(19) United States
(12) Patent Application Publication
(10) Pub. No.: US 2003/0141020 A1
(43) Pub. Date: Jul. 31, 2003

(54) Device for automatically aligning cord tape, which is to be unwound

(76) Inventors: Bernd Hoffmann, Burgkunstadt (DE); Ralf Klenner, Burgkunstadt (DE)

Correspondence Address: JORDAN AND HAMBURG LLP, 122 EAST 42ND STREET, SUITE 4000, NEW YORK, NY, 10168, US

(21) Appl. No.: 10/304,643

(22) Filed: Nov. 26, 2002

(30) Foreign Application Priority Data
Jan. 16, 2002 (DE) 102 01 369.1-22

(51) Int. Cl. B32B 35/00

(52) U.S. Cl. 156/502

(57) ABSTRACT

A device for automatically aligning the leading section of a corded belt, especially a steel-corded belt, unwound from a supply roll, for splicing to the trailing end of the corded belt of the preceding supply roll, comprising suction or magnetic rollers with reversible driving devices, which are provided for the adhering fastening of the downwards starting sagging section of the corded belt

The invention relates to a device for automatically aligning the leading section of a corded belt, especially a steel-corded belt, unwound from a supply roll, for splicing to the trailing end of the corded belt of the preceding supply roll.

When changing from one corded belt roll to the next, the end of the rundown roll must be spliced to the beginning of the new, corded belt roll. For this purpose, it was previously customary for the operator to place the material manually against a magnetic strip in the region of the splicing strip -optionally, the splicing strip itself is constructed as a magnetic strip. Because the end of the belt was cut off at an angle and because the unvulcanized corded belt is very soft and therefore sags and is distorted, stresses and deformations arise during the aligning, so that, after the splicing, large sections must be cut out once again as unusable. Not only does this interrupt the production process, but it is also very expensive because of the high proportion of waste.

It is therefore an object of the invention to provide a device for automatically aligning the material before the splicing and for making a gentle alignment possible, so that, in the final analysis, only the actual splicing sites have to be cut out and there is practically no other waste.

For accomplishing this objective, such a device is characterized pursuant to the invention by suction or magnetic rollers, which are provided with reversible driving devices, for the adhering attachment of the downwardly sagging starting section of the corded belt, two parallel suction or magnetic rollers, which are disposed one above the other, and at least one guide roller, mounted so that it can be displaced axially towards both sides against springs, are disposed ahead of the lower suction or magnetic rollers.

Due to the inventive arrangement, it is achieved that, when the corded belt is stretched while the suction or magnetic rollers are started up, against which the leading end of the new supply roll has been placed eccentrically and optionally also inclined at an angle, force component arise, which are directed transversely to the running direction due to the different tension effects at the two side edges of the belt during the stretching and let the belt slide inwards from its eccentrically offset position due to the different pulling effect at the two side edges of the belt, while the latter is being stretched.

Preferably, the inventive arrangement, although it is also conceivable for suction rollers and textile corded belts, is suitable for steel corded belts with magnetic rollers for the aligning device, since these magnetic rollers can be constructed exceedingly smoothly, so that the transverse force components, arising during the stretching, can let the soft steel corded belt slide into the middle position without the danger of deformations.

In order to avoid blockages, provisions can be made in a development of the invention so that, after the steel-corded belt has been clamped and the obliquely placed corded belt end has been displaced laterally somewhat, the aligning device is stopped and automatically reversed, that is, the aligning device runs a short distance in the opposite direction, so that the belt initially sags once again without lying against the guide rollers. The jolt when re-clamped by being placed against the guide rollers is namely the time, at which the lateral slippage motion of the corded belt, which is still seated eccentrically, functions best. This multiple actuation can also be programmed automatically, so that, for example, tension is applied and reversed once again six for each alignment, in order to align the corded belt end, pulled off from the supply roll, in the middle position in six consecutive steps.

Of course, during the alignment, the belt is moved in the longitudinal direction with the help of the suction or magnetic rollers only by an amount of the order of 20 cm, that is, the extent of the sagging of the section pulled off from the supply roll, since after the stretching following the coming alongside the guide rolls, the belt end at the suction or magnetic rollers slips off in the conveying direction as well as transversely thereto. The transverse slipping, which automatically leads to a shifting into the desired middle position, is important for the inventive alignment.

The possibility of axially displacing the guide roller towards both sides against springs is important, since otherwise the force of friction of the corded belt at the guide roller would block or at least prevent the lateral displacement of the end of the corded belt by the transverse component of force at the suction or magnetic rollers. After each aligning step, the lateral springs bring the guide rollers back into the central starting position. This is helped by the fact that, after the individual aligning steps, the driving device for the suction and magnetic rollers is reversed and, with that, the corded belt sags more once again and accordingly no longer lies against the guide rollers or does so with only very little force.

If magnetic rollers are used, which are preferred for steel corded belts, they should be layered alternately of magnetic and nonmagnetic disks.

The splicing strip for connecting the end of the corded belt of the roll, which has run down, with the starting section of the new supply roll for corded belt may be disposed preferably parallel to the magnetic rollers between these, sensors for detecting the edges of the steel corded belts, which are to be connected, controlling the function.

Further advantages, distinguishing features and details of the invention arise out of the following description of an example, as well as from the drawing, in which

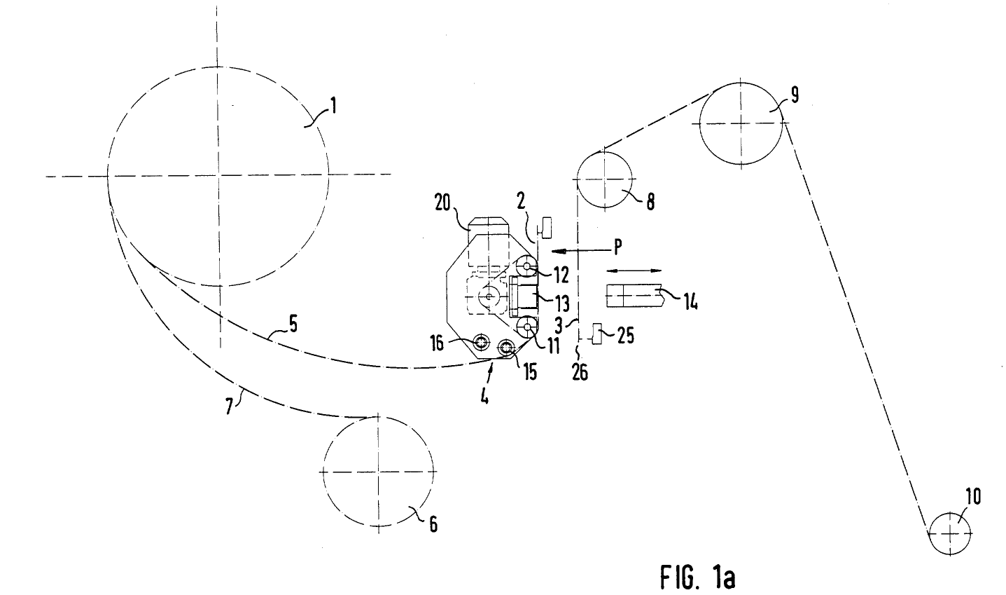

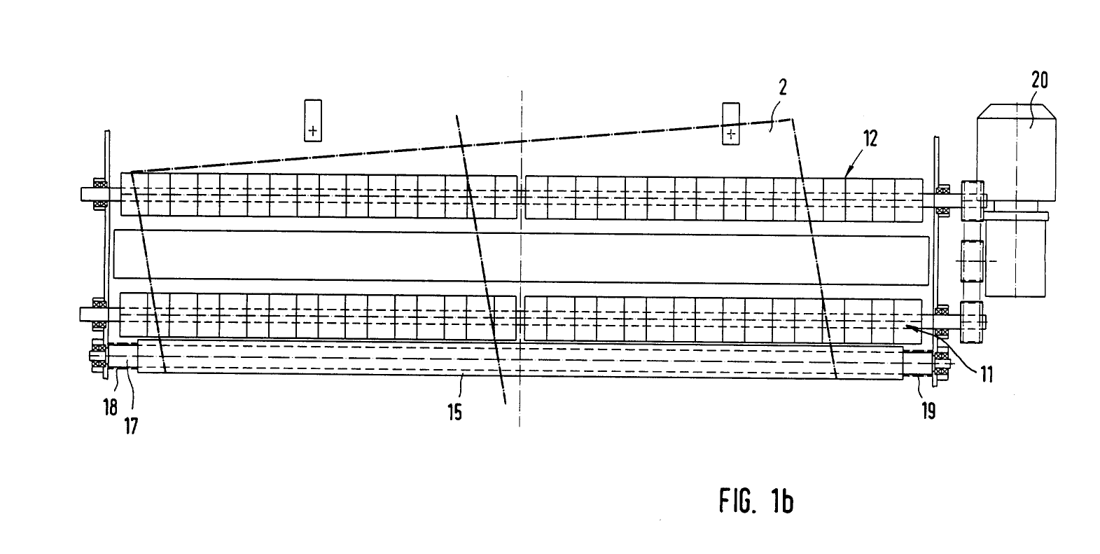

FIG. 1a a side view of the inventive aligning device between a roll, which supplies corded belt, and the pull-off rollers for transporting the belt further to the stations processing the corded belt, in the starting position,

FIG. 1b shows a front view of the aligning device in the direction of the arrow P in FIG. 1 with an end of a corded belt, which is drawn by dots and dashes, offset eccentrically and tilted, in the starting position,

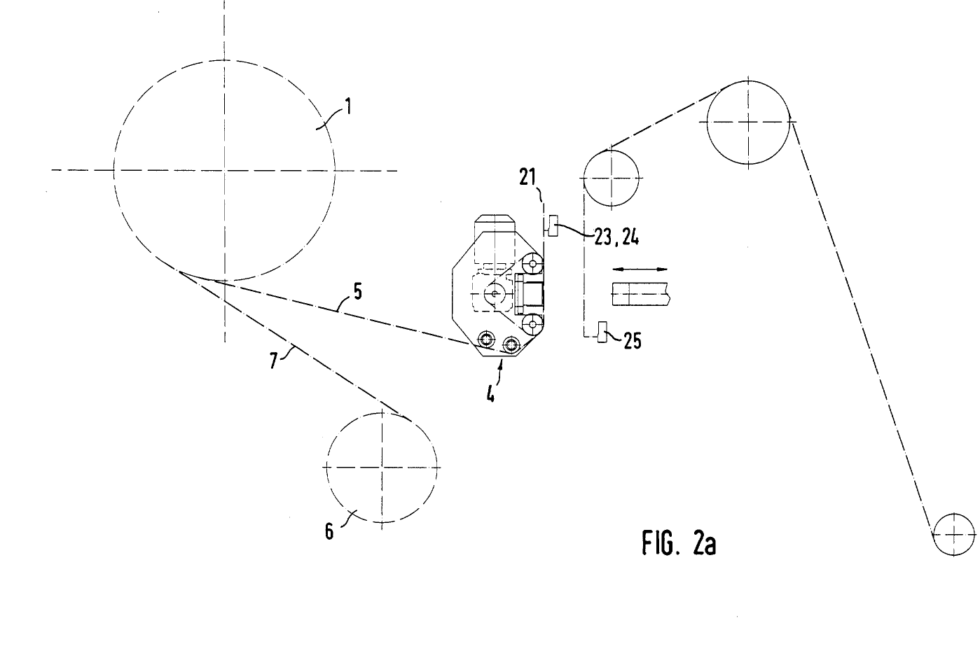

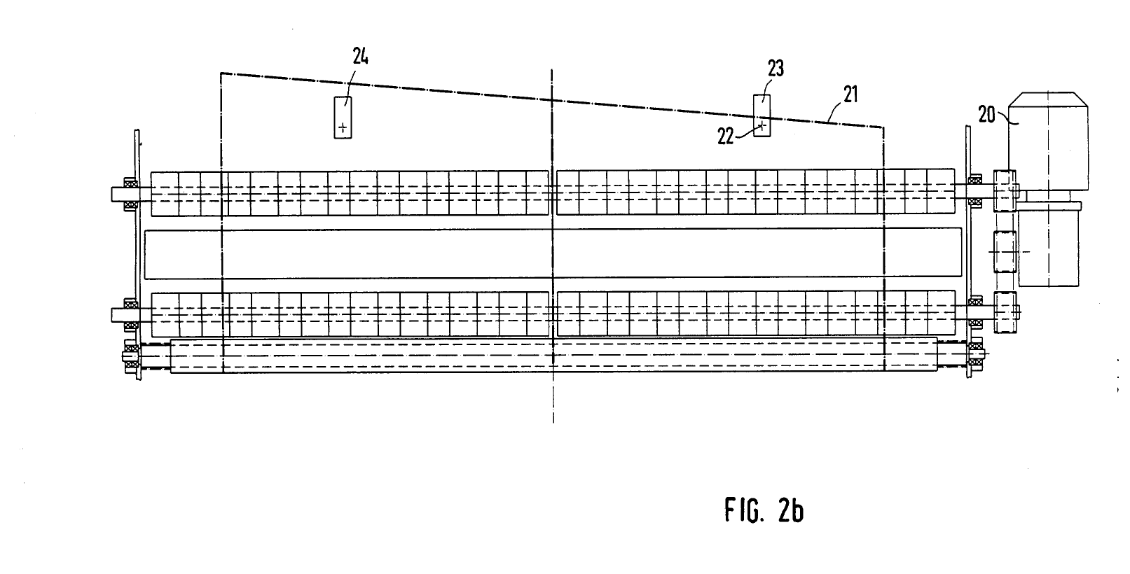

FIG. 2a shows a side view of the arrangement after the corded belt is aligned,

FIG. 2b shows a front view of the aligning device in the position of FIG. 2a

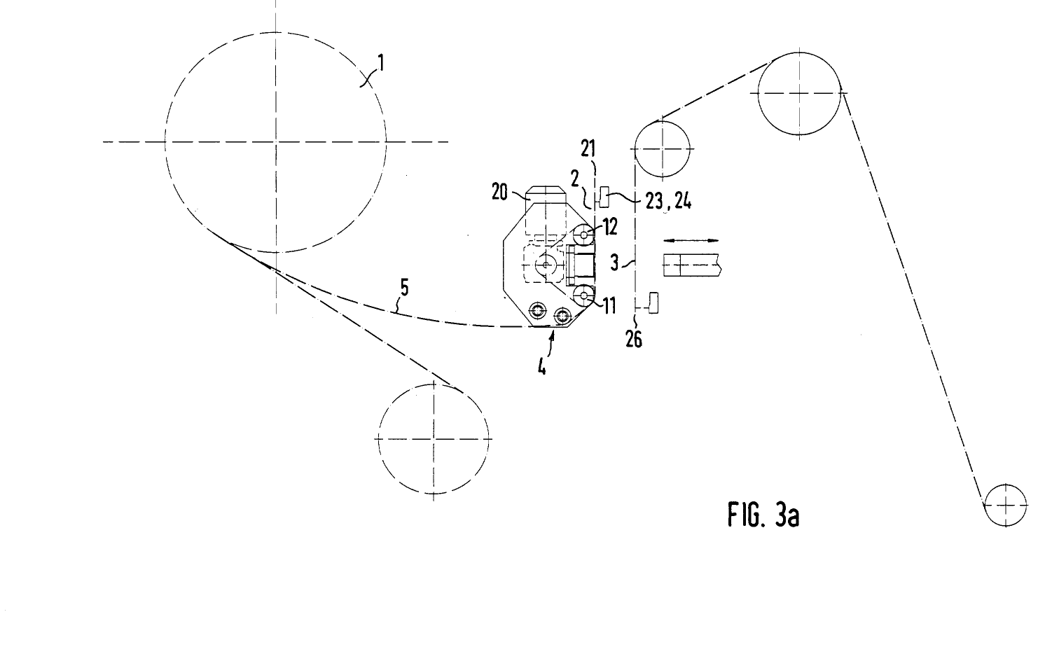

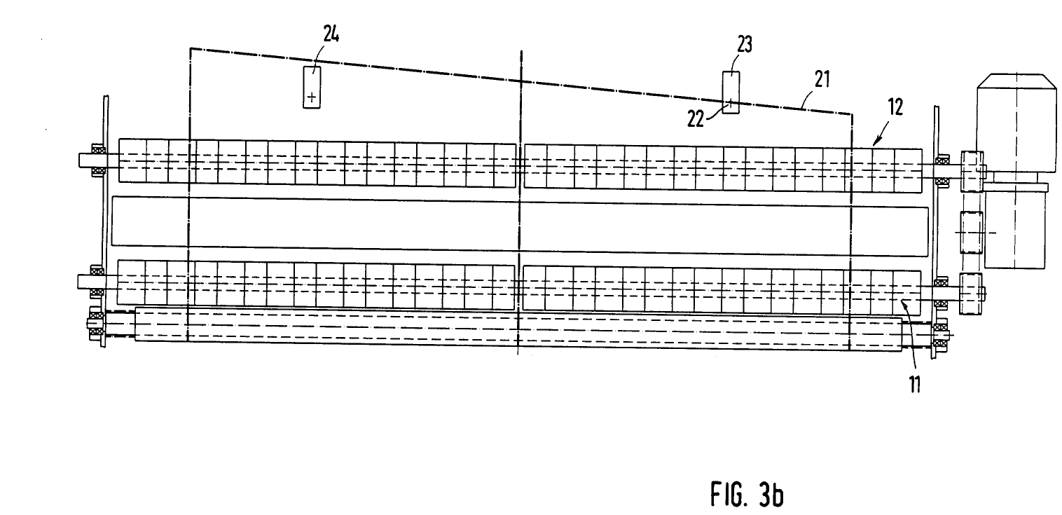

FIG. 3a shows a side view and

FIG. 3b shows a front view of the aligning device after the aligned corded belt has moved back into a sensor-controlled starting position for the splicing and

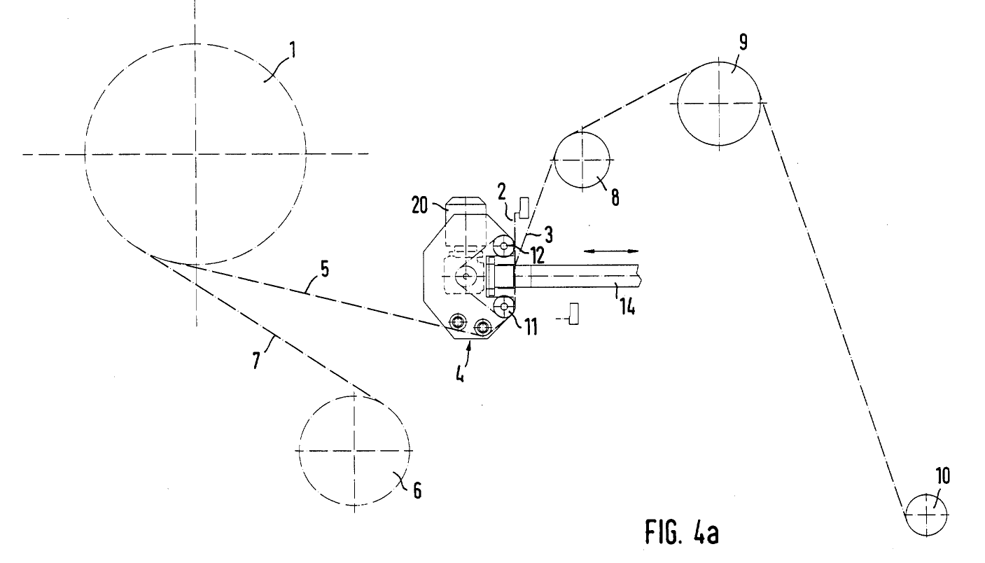

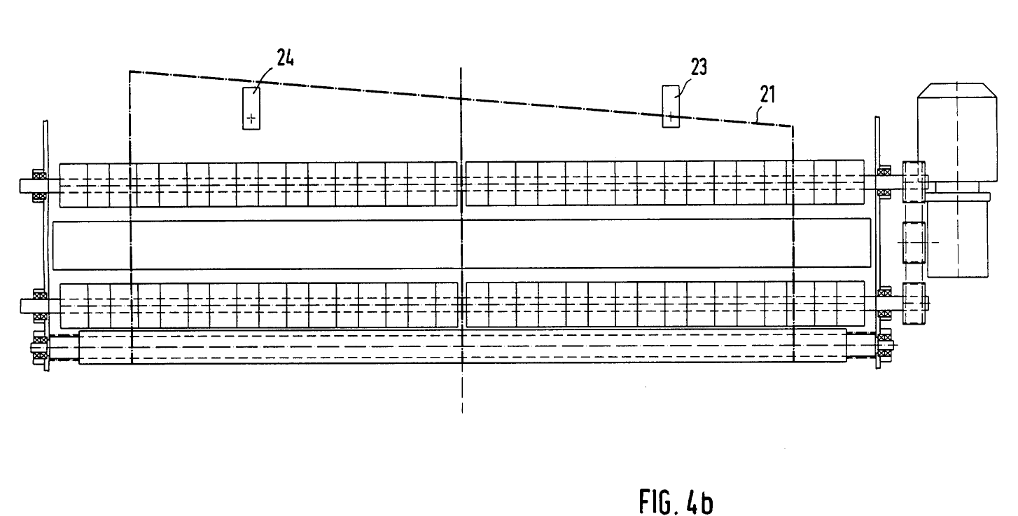

FIGS. 4a and 4b show a side view and a front view of the aligning device with an integrated splicing strip while the two ends of the corded belt are being spliced together.

At 1, a corded belt roll can be seen, the end section 2 of which is to be spliced with the run-down end section 3 of the previous corded belt roll. In order to be able to carry out this splicing without major stresses and displacements, an automatic aligning device 4 is provided pursuant to the invention and takes over the aligning of the leading starting section 2 of the corded belt 5 from the new supply roll 1. At 6, a follower roll can be seen for winding up the tape 7 separating the individual tacky layers of corded belt. Take-off rollers of the subsequent processing station for the corded belt are shown at 8 and 9 and a dancer roller is shown at 10.

In the example shown, the corded belt 5 is a steel corded belt. The inventive device therefore comprises two magnetic rollers 11 and 12, which are disposed one above the other and at a distance from one another and between which the counter strip 13 for the splicing strip 14 is disposed. These magnetic rollers alternately consist of magnetic and non-magnetic disks and enable the end 2 of the corded belt to adhere merely by contact pressure. Below the lower magnetic roller 11, a guide roller 15 is disposed. In those cases, where the supply roll 1 supplies differently, a further guide roller 16 may be provided, which, as can be seen particularly in FIG. 1b, is mounted as a hollow roller on a shaft 17, so that it can be shifted axially to both sides against springs 18, 19. The motor for driving the magnetic rollers 11 and 12 is indicated at 20.

After the end section 2 of the steel corded belt 5, offset and laterally displaced as in FIG. 1b, has been attached by an operator to the magnetic rollers 11 and 12, the latter are caused to rotate and, at the same time, stretch the steel corded belt into the position of FIGS. 2a and 2b. At the same time, if the end 2 of the belt has been applied obliquely, one side becomes tight sooner than the other. By these means, a lateral force is applied to the end 2 of the belt and conveys this end in the direction of the central axis of the magnetic rollers, until both sides are equally tight. When both sides are equally tight, the alignment of the material is completed. However, this aligned position, shown in FIGS. 2a and 2b, generally is attained not by a single actuation of the magnetic roller but by a multi-step process, in which the magnetic rollers, after starting up and tightening the belt (of course, this is not pulled further from the stationary supply roll 1 and, instead, slides through with lateral displacement also in the conveying direction on the magnetic rollers 11 and 12; this means that, in the longitudinal direction above the magnetic roller 12, the edge of the belt is shifted only by the difference between the sagging belt 5 in FIG. 1a and the tight belt in FIG. 2a) are re-directed, so that the belt returns to the position of FIG. 1a. Subsequently, the procedure is started once again and the belt is tightened once more, since, especially at the instant of tightening, that is, of the asymmetric tightening of the one side edge with respect to the other, a particularly high force component is produced in the transverse direction and, with that, a good lateral displacement into the desired, aligned middle position of FIG. 2b. In this connection, it has proven to be appropriate to provide the aligning device with a step control program for six aligning steps. The guide rollers 15, 16 fulfill the purpose of limiting the minimum bending radius during the alignment. They are mounted so that they can be rotated and can easily be shifted laterally on the axis 17, so that they exert little resistance to the alignment. After each aligning step, the lateral springs 18, 19 return the guide rolls 15, 16 back into the central starting position.

After the alignment has been completed, as shown in FIG. 2b, the corded belt is moved back, until the edge 21 of the belt coincides exactly with the response position of the sensor 23, indicated by the cross 22, by changing the direction of the driving device for the magnetic rollers 11 and 12. Subsequently, the splicing strip 14 is actuated and the two ends 2 and 3 of the corded belt, overlapping one another, are spliced. Because these ends 2 and 3 of the corded belt are aligned accurately, only the actual splicing site has to be cut out subsequently. There is no further waste due to distortion and shifting of the belts 2 and 3 relative to one another. In addition to the sensors 23 and 24 for the edge 21 of the belt section 2 of the new corded belt, which is to be pulled off, sensors 25 are provided for holding the take-off rollers 8, 9 in the appropriate, desired end position of the edge 26 of the belt end 3 of the previous supply roll 3.

1. A device for automatically aligning the leading section of a corded belt, especially a steel-corded belt, unwound from a supply roll, for splicing to the trailing end of the corded belt of the preceding supply roll, wherein suction or magnetic rollers (11, 12) with reversible driving devices (20) are provided for the adhering fastening of the downwards sagging starting section (2) of the corded belt (5).

2. The device of claim 1, wherein two parallel suction or magnetic rollers (11, 12), which are disposed one above the other, are provided.

3. The device of claims 1 or 2, wherein the magnetic rollers are layered alternately of magnetic and nonmagnetic disks.

4. The device of one of the claims 1 to 3, wherein, in front of the lower suction or magnetic roller (11), at least one guide roller (15), mounted so that it can be shifted axially towards both sides against springs, is disposed.

5. The device of one of the claims 1 to 4, wherein the driving devices (20) can be redirected repeatedly, in order to achieve alignment in several partial layers.

6. The device of one of the claims 1 to 5, wherein the splicing strip (13, 14) is disposed parallel to the magnetic rollers (11, 12) and between them.

7. The device of claim 6, wherein sensors are provided for detecting the edges (21, 26) of the steel-corded belts (3), which are to be connected.
